(19) United States
(12) Patent Application Publication
(10) Pub. No.: US 2006/0194068 A1
(43) Pub. Date: Aug. 31, 2006

(54) Organosilicon compound and polymer having a cage-type silicon skeleton

(76) Inventors: Takashi Katoh, Ichihara-shi (JP); Takashi Kikukawa, Ichihara-shi (JP); Kenya Ito, Ichihara-shi (JP); Kazuhiro Yoshida, Ichihara-shi (JP); Yasuhiro Yamamoto, Ichihara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/363,203

(22) Filed: Feb. 28, 2006

(30) Foreign Application Priority Data
Feb. 28, 2005 (JP) 2005-53106

(51) Int. Cl. B32B 27/00; C08G 77/04; C08L 83/04

(52) U.S. Cl. 428/447; 528/25

(57) ABSTRACT

The present invention provides a polymer compound comprising a silsesquioxane skeleton represented by the formula (1) in its polymer main chain. 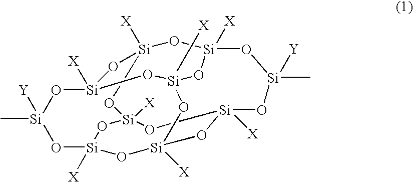 In the formula (1), each of X and Y independently represents hydrogen or a monovalent organic group having 1 to 40 carbon atoms.

### BACKGROUND OF THE INVENTION

1. Field of the Invention

The present relates to a novel polymer having a cage-type silsesquioxane skeleton as its main chain, and a thin film composed of the polymer. The polymer and thin film of the present invention can be used for insulating films, protective films, liquid crystal alignment layers, and optical waveguides in the fields of electronic materials, optical materials, and optoelectronics. The term “silsesquioxane” is a generic name representing a group of compounds in which each silicon atom binds to three oxygen atoms and each oxygen atom binds to two silicon atoms. In the present invention, a compound having a silsesquioxane-like structure resulting from deformation of part of the silsesquioxane structure is also included in the scope of “silsesquioxane.” The term “silsesquioxane skeleton” is used as a generic name for the silsesquioxane structure and the silsesquioxane-like structure. Hereinafter, the term “silsesquioxane” maybe represented as “PSQ”.

2. Description of the Related Art

A large number of studies have been so far conducted on the PSQ. For example, according to the review described in Chem. Rev. 95, 1409 (1995), the presence of PSQ having an amorphous structure and not showing a constant structure has been identified in addition to PSQ having a ladder structure, a completely condensed structure, or an incompletely condensed structure. The term “completely condensed structure” refers to a structure composed of multiple cyclic structures to form a closed space, and the shape of the closed space is not limited. The term “incompletely condensed structure” refers to a structure in which at least one site of the completely condensed structure is not sealed and whose space is not closed.

Among PSQ's each having a completely condensed structure or an incompletely condensed structure, the number of compounds that can be easily synthesized and isolated is limited. Furthermore, the number of commercially available compounds among such compounds is also limited. PSQ derivatives obtained by introducing various functional groups into a PSQ having a completely condensed structure or an incompletely condensed structure have been recently commercially available from HYBRID PLASTICS, and a large number of applications of such derivatives have been proposed.

However, most of such commercially available PSQ derivatives are mainly of a completely condensed structure (so-called T8 structure), and PSQ derivatives having an incompletely condensed structure generally have a cage-structure with only one unclosed part (T7 structure). Therefore, a completely condensed derivative is often blended in a resin as an additive when such PSQ derivative is used. However, existing PSQ derivatives have some problems: that is, the derivatives have poor compatibility with a resin, so that they cannot be uniformly mixed with the resin, they become white when formed into a coating film, and they bleed out from the coating film. Therefore, the amount of the derivatives to be added is limited, and in not a few cases, properties inherent for PSQ such as flame retardancy, heat resistance, antiweatherability, light resistance, electrical insulating property, surface property, hardness, mechanical strength, and chemical resistance cannot be sufficiently exerted.

On the other hand, in some cases, an incompletely condensed PSQ skeleton is introduced into a resin by a method except the blending. Macromolecules, 28, 8435, (1995) discloses a cage-type PSQ having methacryloyl group. A polymer obtained by polymerizing the compound has high mechanical strength and high oxygen permeability. Furthermore, in Macromolecules, 36, 9122, (2003), a polyimide having PSQ skeleton in a side chain is synthesized by circularizing an uncondensed portion of T7 structure using a trichlorosilane derivative and then synthesizing a diamine. However, each of these compounds involves a problem in terms of structural chemistry originating from the T7 skeleton that PSQ can be introduced only into a side chain.

A novel PSQ skeleton having two uncondensed sites (which may hereinafter be abbreviated as “double-decker skeleton”) has been recently developed. WO 2004/024741 discloses that the compound reacts with any one of various dichlorosilanes to close its ring, thereby yielding a cage-type silicon compound similar to a completely condensed PSQ. Furthermore, a polymer having the double-decker skeleton shown in the formula (1) in its main chain was first synthesized by introducing a functional group into the closed-ring site followed by polymerization (JP2004-331647A). However, the disclosed polymers are limited to a multi-addition products produced by hydrosilylation, polyimide, and ring-opening polymers of cyclic ethers such as epoxy and oxetane, and the document describes neither polymers other than those described above nor whether such polymers could be synthesized. In addition, each of the polymers disclosed in the document has a low glass transition point because each of their monomers has a large number of flexible methylene bonds. Therefore, the polymers cannot exert sufficiently the properties of a cage-type silicon skeleton which is rigid and excellent in heat resistance.

### SUMMARY OF THE INVENTION

An object of the present invention is to provide a novel polymer compound having a double-decker skeleton in its main chain and a reactive compound serving as a raw material for the polymer compound. In particular, an object of the present invention is to provide a material excellent in heat resistance and mechanical strength by making a molecular chain as rigid as possible.

Another object of the present invention is to provide a novel optoelectronics material using a thin film of such polymer, specifically, to provide a material for an insulating film having a low dielectric constant, a liquid crystal alignment layer excellent in light resistance; or an optical waveguide having a low transmission loss.

The inventors of the present invention have made extensive studies in view of creating an organic-inorganic hybrid material containing a controlled cage-type structure by introducing a double-decker skeleton into any one of various organic polymer main chains. As a result, they have succeeded in obtaining a polyimide, polyamide, polyester, polycarbonate, polyurethane, polyphenylene, and epoxy resin having a main chain with a cage-type silicon skeleton by synthesizing and polymerizing a bifunctional compound containing a polymerizable group such as amino group, hydroxyl group, acid anhydride, or carbon-carbon unsaturated bond. Furthermore, they have found that a thin film of such novel polymers is excellent in dielectric property, transparency, light resistance, heat resistance, and the like, and is useful for an electronic material such as an insulating film, a liquid crystal alignment layer, or an optical waveguide, thereby completed the present invention.

It is an object of the present invention to provide a polymer compound comprising a silsesquioxane skeleton represented by the formula (1) in its polymer main chain.

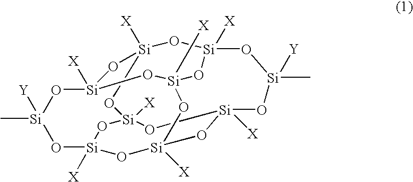

In the formula (1), each of X and Y independently represents a hydrogen or a monovalent organic group having 1 to 40 carbon atoms.

It is a further object of the present invention to provide the polymer compound as described above, wherein: X in the formula (1) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen maybe replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

It is a further object of the present invention to provide the polymer compound as described above, wherein X in the formula (1) independently represents methyl, ethyl, propyl, cyclohexyl, or phenyl.

It is a further object of the present invention to provide the polymer compound as described above, wherein X in the formula (1) is phenyl.

It is a further object of the present invention to provide the polymer compound as described above, wherein Y in the formula (1) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and the optional —CH₂— in the alkylene of the arylalkyl may be replaced by —O—, —CH═CH—, or cycloalkylene.

It is a further object of the present invention to provide the polymer compound as described above, wherein the main chain of the polymer is a polyimide.

It is a further object of the present invention to provide a polymer compound as described above, wherein the main chain of the polymer is a polyamide.

It is a further object of the present invention to provide the polymer compound as described above, wherein the main chain of the polymer is a polyester.

It is a further object of the present invention to provide the polymer compound as described above, wherein the main chain of the polymer is a polycarbonate.

It is a further object of the present invention to provide the polymer compound as described above, wherein the polymer main chain is a polyurethane.

It is a further object of the present invention to provide the polymer compound as described above, wherein the main chain of the polymer is a polyphenylene.

It is a further object of the present invention to provide the polymer compound as described above, wherein the main chain of the polymer is an epoxy resin.

It is a further object of the present invention to provide an organosilicon compound represented by the formula (2).

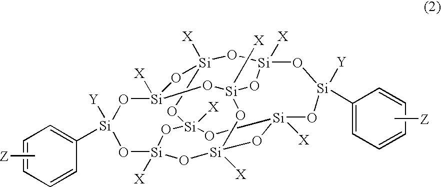

In the formula (2), each of X and Y independently represents a hydrogen or a monovalent organic group having 1 to 40 carbon atoms, and Z independently represents an amino group, hydroxyl, vinyl, epoxy, or triple bond-containing group (—C≡C—R) wherein R represents a hydrogen or a monovalent organic group having 1 to 10 carbon atoms.

It is a further object of the present invention to provide the organosilicon compound represented by the formula (2) as described above, wherein: X in the formula (2) independently represents hydrogen, alkyl having 1 to 40 carbon atoms whereby optional hydrogen may be replaced by fluorine and optional —CH₂— maybe replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

It is a further object of the present invention to provide the organosilicon compound represented by the formula (2) as described above, wherein X in the formula (2) independently represents methyl, ethyl, propyl, cyclohexyl, or phenyl.

It is a further object of the present invention to provide the organosilicon compound represented by the formula (2) as described above, wherein X in the formula (2) is phenyl.

It is a further object of the present invention to provide the organosilicon compound represented by the formula (2) as described above, wherein: Y in the formula (2) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

It is a further object of the present invention to provide an organosilicon compound represented by the formula (3).

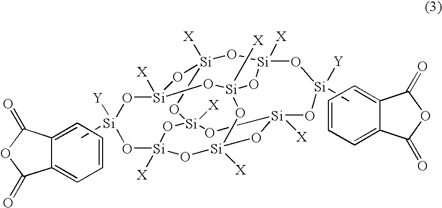

In the formula (3), each of X and Y independently represents hydrogen or a monovalent organic group having 1 to 40 carbon atoms.

It is a further object of the present invention to provide the organosilicon compound as described above, wherein: X in the formula (3) independently represents hydrogen, alkyl having 1 to 40 carbon atoms in which optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

It is a further object of the present invention to provide the organosilicon compound represented by the formula (3) as described above, wherein X in the formula (3) independently represents methyl, ethyl, propyl, cyclohexyl, or phenyl.

It is a further object of the present invention to provide the organosilicon compound represented by the formula (3) as described above, wherein X in the formula (3) is phenyl.

It is a further object of the present invention to provide the organosilicon compound represented by the formula (3) as described above, wherein: Y in the formula (3) independently represents: hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine, and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

It is a further object of the present invention to provide the polymer compound as described above, which is obtained by performing a polymerization reaction by means of the organosilicon compound represented by the formula (2) as described above as a monomer.

It is a further object of the present invention to provide the polymer compound having polyimide as a main chain as described above, which is obtained by performing a polymerization reaction by means of the organosilicon compound represented by the formula (3) as described above as a monomer.

It is a further object of the present invention to provide the polymer compound having polyimide as a main chain as described above, wherein the polymer compound is obtained by performing polymerization using the organosilicon compound represented by the formula (2) as described above in which Z represents an amino group, and the organosilicon compound represented by the formula (3) as described above.

It is a further object of the present invention to provide a thin film comprising the polymer compound as described above.

It is a further object of the present invention to provide an insulating film comprising the thin film as described above.

It is a further object of the present invention to provide a protective film comprising the thin film as described above.

It is a further object of the present invention to provide a liquid crystal alignment layer comprising the thin film as described above.

It is a further object of the present invention to provide a planarized film comprising the thin film as described above.

It is a further object of the present invention to provide a material for an optical waveguide comprising the thin film as described above.

It is a further object of the present invention to provide an electrical solid state device comprising the insulating film as described above.

It is a further object of the present invention to provide an electrical solid state device comprising the protective film as described above.

It is a further object of the present invention to provide a liquid crystal display comprising the liquid crystal alignment layer according to claim 29.

It is a further object of the present invention to provide a liquid crystal display comprising the planarized film as described above.

It is a further object of the present invention to provide an optical waveguide comprising the material for an optical waveguide as described above.

The polymer compound of the present invention can be obtained by polymerizing a bifunctional double-decker derivative by means of a conventionally known method.

The polymer compound of the present invention has, in its main chain, a rigid cage-type skeleton excellent in mechanical strength and heat resistance. In addition, a gap is present inside the double-decker skeleton, so the polymer compound of the present invention is excellent in heat resistance and the like, and, in addition, shows a low dielectric constant. Furthermore, the polymer compound of the present invention is superior in transparency and light resistance to polymers of a similar kind composed only of organic residues, because the content of organic silicon components in the entire polymer is large. Therefore, the polymer compound of the present invention is useful for an electronic material such as an interlayer insulating film or optical waveguide which is used under harsh conditions, as compared to conventional organic polymers.

### DETAILED DESCRIPTION OF EXEMPLARY EMBODIMENTS

The polymer compound of the present invention is a polymer compound having a silsesquioxane skeleton represented by the formula (1) in its polymer main chain.

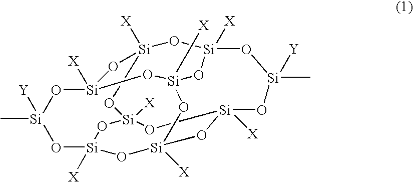

In the formula (1), X independently represents hydrogen or monovalent organic group having 1 to 40 carbon atoms. Preferably, X independently represents hydrogen, alkyl having 1 to 40 carbon atoms, aryl whose optional hydrogen may be replaced by halogen or alkyl having 1 to 20 carbon atoms, or arylalkyl in which optional hydrogen in the aryl may be replaced by halogen or alkyl having 1 to 20 carbon atoms. Here, optional hydrogen in the alkyl having 1 to 40 carbon atoms may be replaced by fluorine, and optional —CH₂— in the alkyl may be replaced by —O—, —CH═CH—, cycloalkylene, or cycloalkenylene. Optional hydrogen in the alkyl having 1 to 20 carbon atoms as a substituent for the aryl may be replaced by fluorine, and optional —CH₂— in the alkyl may be replaced by —O—, —CH═CH—, cycloalkylene, or phenylene. Optional hydrogen in the alkylene of the arylalkyl may be replaced by fluorine, and optional —CH₂— in the alkylene may be replaced by —O—, —CH═CH—, or cycloalkylene.

Specific examples of X are as follows.

Examples of alkyl include methyl; ethyl; propyl; 1-methylethyl; butyl; 2-methylpropyl; 1,1-dimethylethyl; pentyl; hexyl; 1,1,2-trimethylpropyl; heptyl; octyl; 2,4,4-trimethylpentyl; nonyl; decyl; undecyl; dodecyl; tetradecyl; hexadecyl; octadecyl; and eicosyl.

Examples of cycloalkyl include cyclobutyl, cyclopentyl, cyclohexyl, cycloheptyl, cyclooctyl, and decalyl.

Examples of fluoroalkyl include 3,3,3-trifluoropropyl; 3,3,4,4,5,5,6,6,6-nonadecafluorohexyl; tridecafluoro-1,1,2,2-tetrahydrooctyl; heptadecafluoro-1,1,2,2-tetrahydrodecyl; perfluoro-1H,1H,2H,2H-dodecyl; and perfluoro-1H,1H,2H,2H-tetradecyl.

Examples of alkoxy include 3-methoxypropyl; methoxyethoxyundecyl; and 3-heptafluoroisopropoxypropyl.

X may be an organic group having an unsaturated bond like alkenyl. Specific examples thereof include: ethenyl; 2-propenyl; 3-butenyl; 5-hexenyl; 7-octenyl; and 10-undecenyl.

An example of alkenyloxyalkyl having 2 to 20 carbon atoms includes allyloxyundecyl group.

Examples of substituted or unsubstituted aryl include: phenyl; naphthyl; anthranyl; fluorenyl; pentafluorophenyl; 4-fluorophenyl; 4-chlorophenyl; 4-bromophenyl; 4-methylphenyl; 4-ethylphenyl; 4-propylphenyl; 4-butylphenyl; 4-pentylphenyl; 4-heptylphenyl; 4-octylphenyl; 4-nonylphenyl; 4-decylphenyl; 2,4-dimethylphenyl; 2,4,6-trimethylphenyl; 2,4,6-triethylphenyl; 4-(1-methylethyl)phenyl; 4-(1,1-dimethylethyl)phenyl; 4-(2-ethylhexyl)phenyl; 2,4,6-tris(1-methylethyl)phenyl; 4-methoxyphenyl; 4-ethoxyphenyl; 4-propoxyphenyl; 4-butoxyphenyl; 4-pentyloxyphenyl; 4-heptyloxyphenyl; 4-decyloxyphenyl; 4-octadecyloxyphenyl; 4-(1-methylethoxy)phenyl; 4-(2-methylpropoxy)phenyl; 4-(1,1-dimethylethoxy)phenyl; 4-ethenylphenyl; 4-(1-methylethenyl)phenyl; and 4-(3-butenyl)phenyl.

Of the above-mentioned substituent groups, a lower alkyl or aryl, which is excellent in heat resistance and mechanical strength, is preferable as a monovalent organic group to be used for the polymer compound of the present invention and for the organosilicon compound serving as a raw material for the polymer compound. Specific examples of a particularly preferable monovalent organic group include methyl, ethyl, propyl, cyclohexyl, and phenyl. Of those, phenyl is most preferable.

In the formula (1), Y independently represents hydrogen or a monovalent organic group having 1 to 40 carbon atoms. Preferably, Y independently represents hydrogen, alkyl having 1 to 40 carbon atoms, aryl whose optional hydrogen may be replaced by halogen or alkyl having 1 to20 carbon atoms, or arylalkyl in which optional hydrogen in the aryl may be replaced by halogen or alkyl having 1 to 20 carbon atoms. Here, optional hydrogen in the alkyl having 1 to 40 carbon atoms may be replaced by fluorine, and optional —CH₂— in the alkyl may be replaced by —O—, —CH═CH—, cycloalkylene, or cycloalkenylene. Optional hydrogen in the alkyl having 1 to 20 carbon atoms as a substituent for the aryl may be replaced by fluorine, and optional —CH₂— in the alkyl may be replaced by —O—, —CH═CH—, cycloalkylene, or phenylene. Optional hydrogen in the alkylene of the arylalkyl maybe replaced by fluorine, and optional —CH₂— in the alkylene may be replaced by —O—, —CH═CH—, or cycloalkylene. Specific examples of particularly preferable group include methyl, ethyl, propyl, butyl, pentyl, hexyl, heptyl, cyclobutyl, cyclopentyl, cyclohexyl, and phenyl. Trifluoromethyl, trifluoropropyl, pentafluoroethyl, or fluorophenylene group which is obtained by substituting a hydrogen atom in each of those hydrocarbon groups with fluorine is also preferable. The positions of bonding groups in those hydrocarbon groups are optional.

The polymer compound of the present invention, which can be produced by means of a typical polymer chemical procedure, can be suitably synthesized by polymerizing a bifunctional monomer having the reactive group exemplified in the formula (2) or (3).

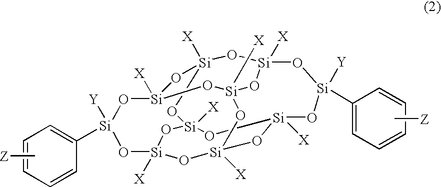

Here, X and Y represent substituents defined in the same way as in the formula (1), and preferable substituents are the same as those of the formula (1).

Z independently represents amino group, hydroxyl, vinyl, epoxy, or triple bond-containing group (—C≡C—R) where R represents hydrogen or monovalent organic group having 1 to 10 carbon atoms.

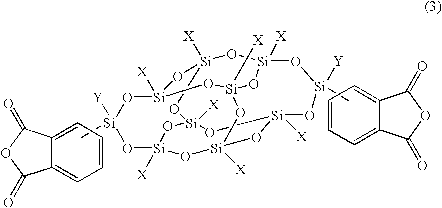

Here, X and Y represent substituents defined in the same way in the formula (1), and preferable substituents are the same as those of the formula (1).

Each of those bifunctional monomers, which can also be easily synthesized by means of a conventional organic chemical procedure, is generally synthesized through a ring-closing reaction between a dichlorosilane derivative having a reactive group and the double-decker-type PSQ shown in the formula (a). General procedures of synthesizing the compounds represented by the formula (2) and (3) are shown below.

The double-decker-type PSQ can be obtained by subjecting trialkoxysilane to hydrolysis and followed by polycondensation in the presence of sodium hydroxide.

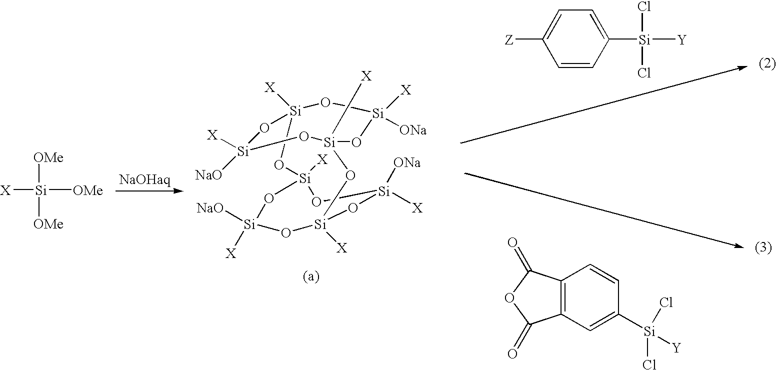

A synthesis method comprising circularizing the compound of the formula (a) with a dichlorosilane derivative having an elimination group (E); and allowing the resultant compound to react with Grignard reagent having a reactive group may be used. An example of such reaction is shown below.

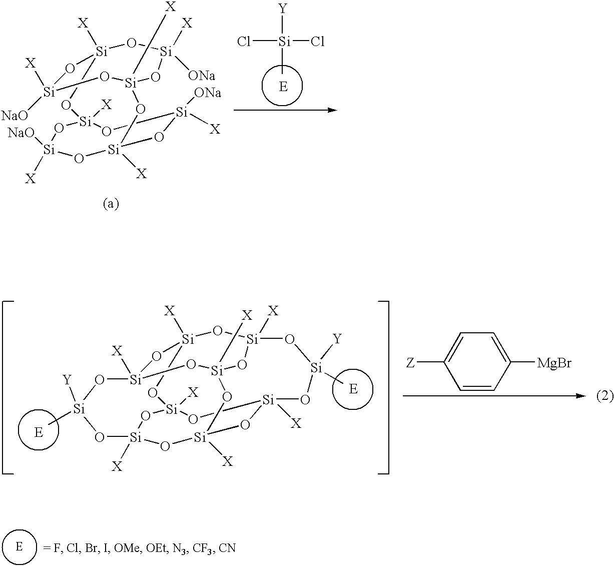

Compounds other than those of the formulae (2) and (3) can also be obtained similarly.

The polymer compound of the present invention can be obtained by performing a polymerization reaction by means of the thus obtained compound as a monomer.

A polymerization reaction is shown below.

The polymer compound of the present invention having polyimide as a main chain can be synthesized by a polymerization reaction between a diamine having a skeleton represented by the formula (1), such as a compound represented by the formula (2) in which Z is an amino group, and a tetracarboxylic dianhydride. An example of such reaction is shown below. In the formula, “A” represents a divalent organic group.

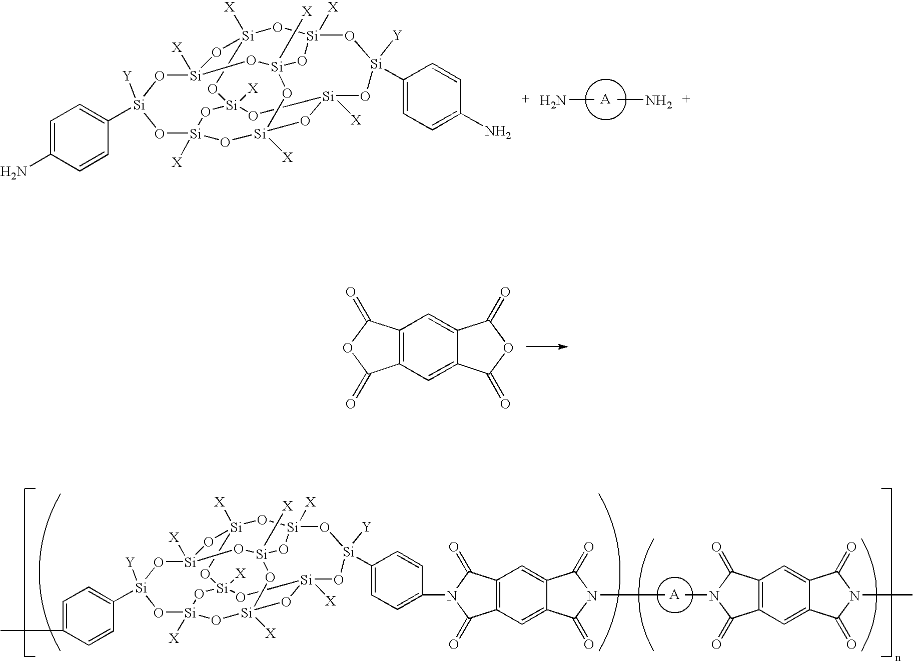

The tetracarboxylic dianhydride to be used as a monomer in the production of the polyimide of the present invention is not particularly limited. Specific examples of the tetracarboxylic dianhydride include: pyromellitic dianhydride; 3,3′,4,4′-biphenyltetracarboxylic dianhydride; 2,2′,3,3′-biphenyltetracarboxylic dianhydride; 2,3,3′,4′-biphenyltetracarboxylic dianhydride; 3,3′,4,4′-benzophenonetetracarboxylic dianhydride; 2,3,3′,4′-benzophenonetetracarboxylic dianhydride; 2,2′,3,3′-benzophenonetetracarboxylic dianhydride; bis(3,4-dicarboxyphenyl)ether dianhydride; a bis(3,4-dicarboxyphenyl)sulfone dianhydride; 1,2,5,6-naphthalenetetracarboxylic dianhydride; 2,3,6,7-naphthalenetetracarboxylic dianhydride; bis(dicarboxyphenyl)methane dianhydride; cyclobutanetetracarboxylic dianhydride; cyclopentanetetracarboxylic dianhydride; cyclohexanetetracarboxylic dianhydride; dicyclohexanetetracarboxylic dianhydride; dicyclopentanetetracarboxylic dianhydride; bis(dicarboxycyclohexyl)ether dianhydride; bis(dicarboxycyclohexyl)sulfone dianhydride; bis(dicarboxycyclohexyl)methane dianhydride; and 4,4′-(hexafluoroisopropylidene)diphthalic dianhydride. A compound represented by the formula (3) can also be used.

Of those, pyromellitic dianhydride, 3,3′,4,4′-biphenyltetracarboxylic dianhydride, 3,3′,4,4′-benzophenonetetracarboxylic dianhydride, bis(3,4-dicarboxyphenyl)ether dianhydride, bis(3,4-dicarboxyphenyl)sulfone dianhydride, cyclobutanetetracarboxylic dianhydride, bis(dicarboxycyclohexyl)methane dianhydride, 4,4′-(hexafluoroisopropylidene)diphthalic dianhydride, and the compound represented by the formula (3) are preferable. Some of those compounds contain isomers. A mixture of such isomers is also available. In addition, two or more kinds of compounds may be used in combination.

The polymer compound of the present invention having polyamide as a main chain can be synthesized by a polymerization reaction between a diamine having a skeleton represented by the formula (1) such as a compound represented by the formula (2) in which Z is an amino group, and dicarboxylic acid or derivative thereof. An example of such reaction is shown below. In the formula, each of A and B represents a divalent organic group.

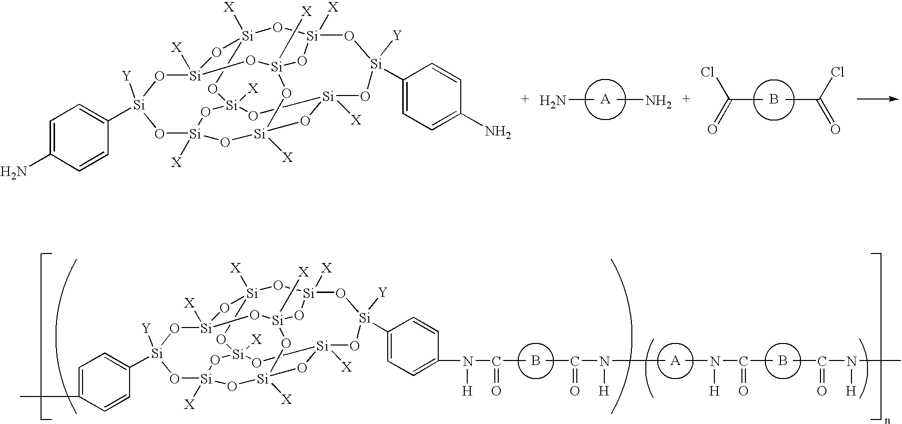

Although the above-mentioned dicarboxylic acid to be used as a monomer in the polyamide of the present invention may be used for polymerization as it is, the reaction proceeds more moderately if a reactive derivative of such dicarboxylic acid is used for polymerization. Examples of such a derivative of include: acid halide such as carboxylic acid chloride; and active ester such as 1-hydroxybenzotriazolyl ester, 2,4-dinitrophenyl ester, and N-hydroxysuccinimide ester. Among these derivatives of dicarboxylic acid, acid chloride derivative is preferable.

The polymer compound of the present invention having polyester as a main chain can be synthesized by a polymerization reaction between diol or biphenol having a skeleton represented by the formula (1) such as a compound represented by the formula (2) in which Z is hydroxyl group, and dicarboxylic acid or a derivative thereof. An example of such a reaction is shown below. In the formula, each of A and B represents a divalent organic group.

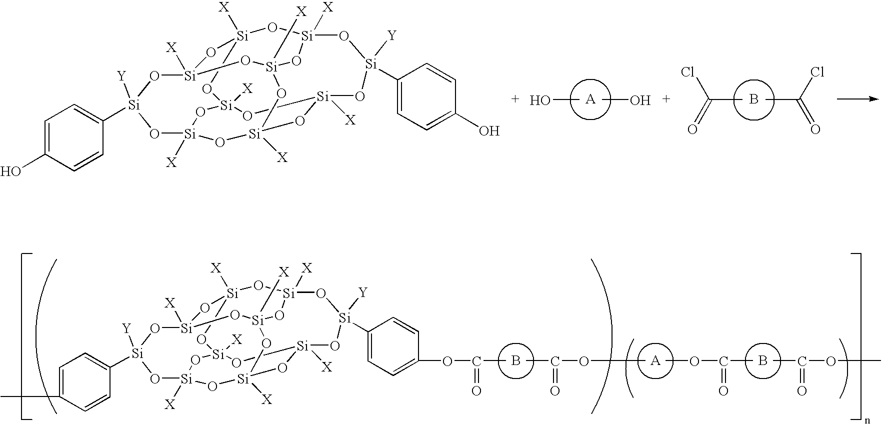

Although the above-mentioned dicarboxylic acid to be used in the polyester of the present invention may be used for polymerization as it is, the reaction proceeds more moderately if a reactive derivative of such dicarboxylic acid is used for polymerization. Examples of such derivatives include: acid halide such as a carboxylic acid chloride; and active ester such as 1-hydroxybenzotriazolyl ester, 2,4-dinitrophenyl ester, and N-hydroxysuccinimide ester. Alternatively, polymerization may be performed through ester exchange reaction based on melt-polymerization by using phenyl ester. Among these derivatives, acid chloride derivative is preferable.

The polymer compound of the present invention having polycarbonate as a main chain can be synthesized by a polymerization reaction between a diol or a biphenol having a skeleton represented by the formula (1) such as a compound represented by the formula (2) in which Z is hydroxyl, and a carbonic acid or a derivative thereof. An example of such reaction is shown below. In the formula, A represents a divalent organic group.

Specific examples of the carbonic acid derivative to be used in the synthesis of the polycarbonate of the present invention include: chloride such as phosgene, trichloromethyl chloroformate (phosgene dimer), or triphosgene; and carbonate such as dimethyl carbonate and diphenyl carbonate. Among these derivatives, triphosgene derivative and diphenyl carbonate derivative are preferable.

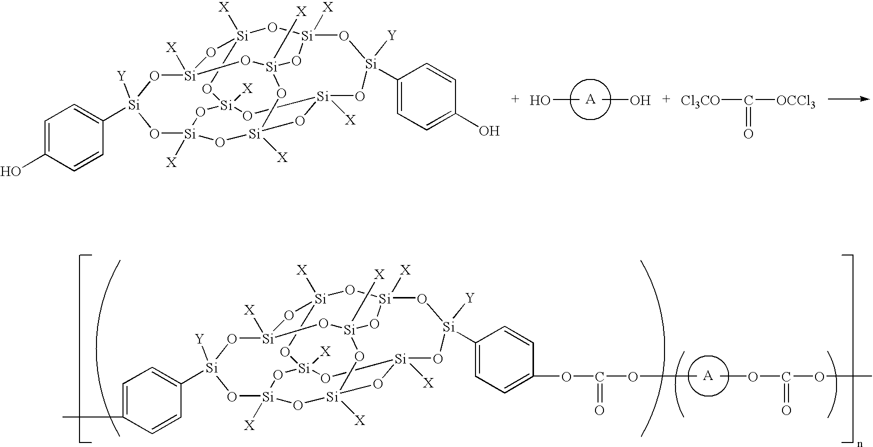

The polymer compound of the present invention having polyurethane as a main chain can be synthesized by polyaddition reaction between diol or biphenol having a skeleton represented by the formula (1) such as a compound represented by the formula (2) in which Z is hydroxyl, and diisocyanate. An example of such a reaction is shown below. In the formula, each of A and B represents a divalent organic group.

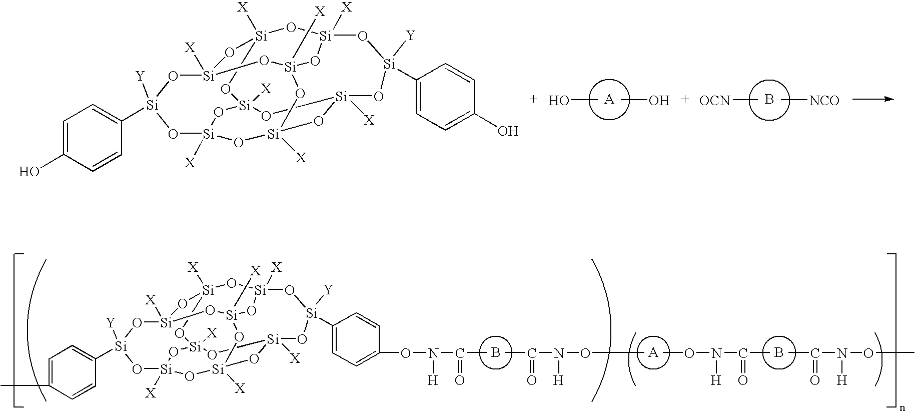

The polymer compound of the present invention having polyphenylene as a main chain can be synthesized by polyaddition reaction between a compound having a skeleton represented by the formula (1) and two triple bonds such as a compound represented by the formula (2) in which Z is —C≡C—R, and a conjugate diene or a derivative thereof. An example of such reaction is shown below. In the formula, each of A and B represents a divalent organic group.

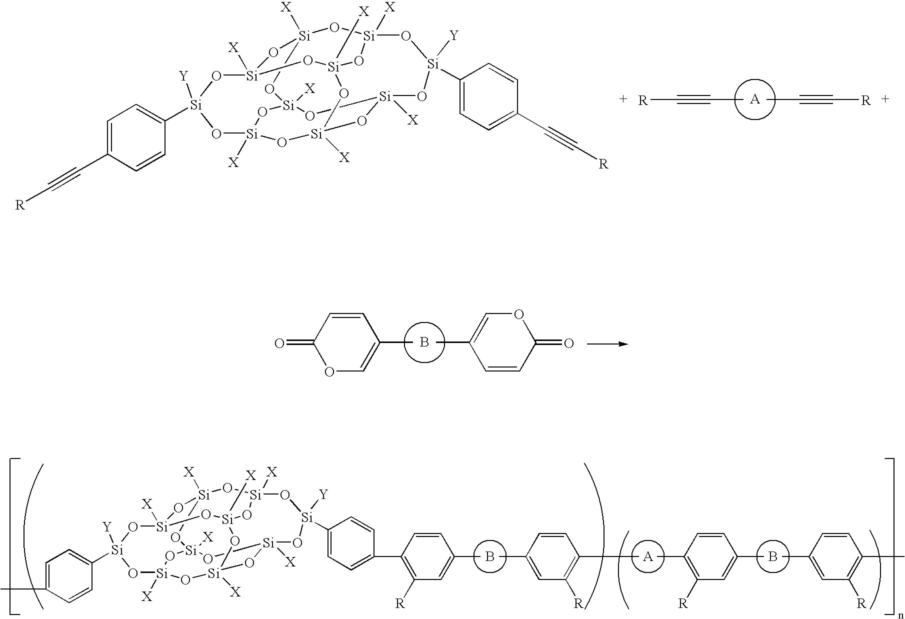

In this case, examples of a conjugate diene or a derivative thereof to react with the triple bond can include the following structures. In the formulae, B represents a divalent organic group, which is described later.

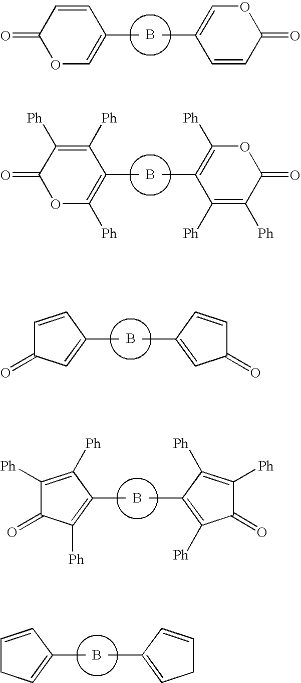

Of those structures, preferable are the following structures which finally forms a benzene ring through the elimination of carbon monoxide or carbon dioxide after Diels-Alder reaction.

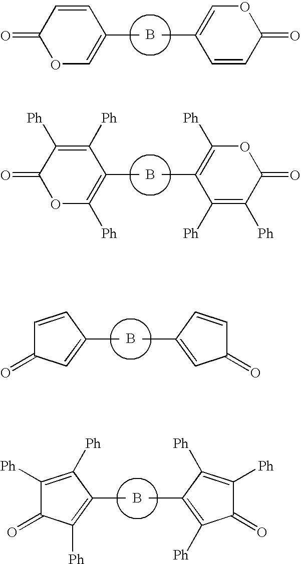

Divalent organic groups corresponding to A and B in a compound to be used as a monomer in the synthesis of the polymer compound of the present invention are not particularly limited, but preferable are such groups as described below. Those groups are independent of each other, and require no third component when no copolymer is synthesized. Some of those compounds contain isomers. A mixture of those isomers may also be used. In addition, two or more kinds of compounds may be used in combination. Examples of an aromatic group are shown below.

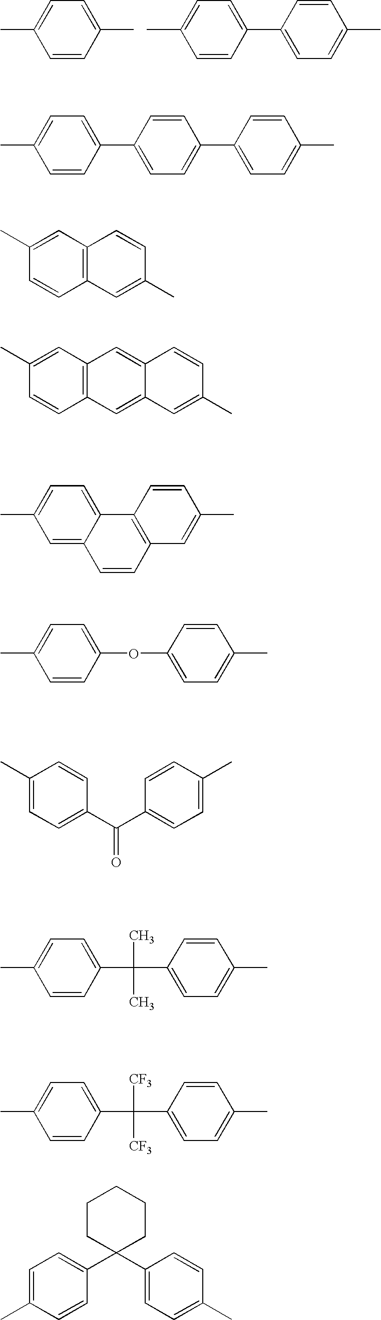

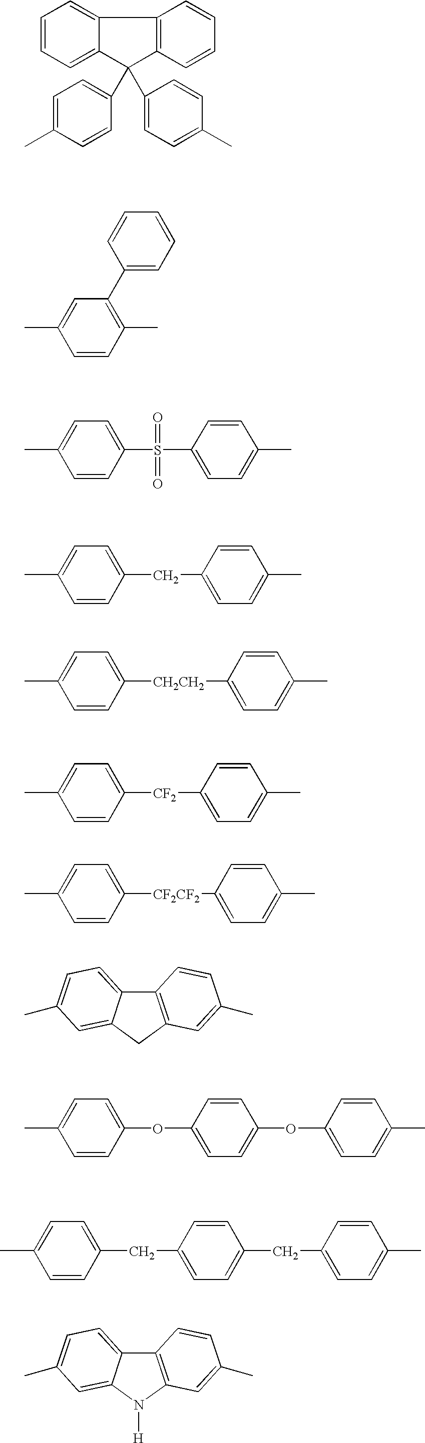

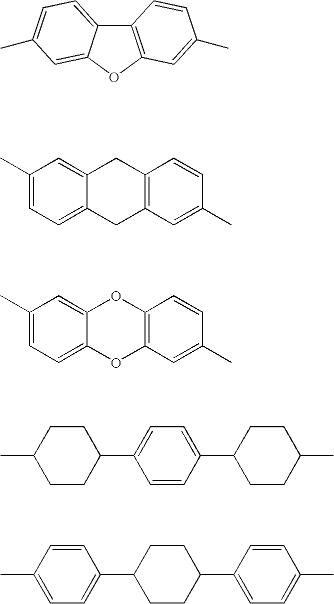

The following aliphatic groups can also be exemplified.

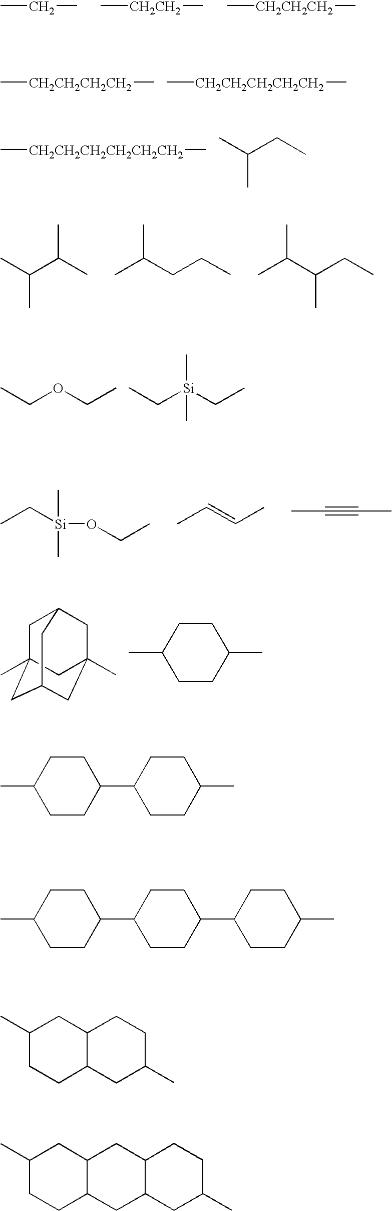

Of those divalent organic groups, the following structures are particularly preferably used.

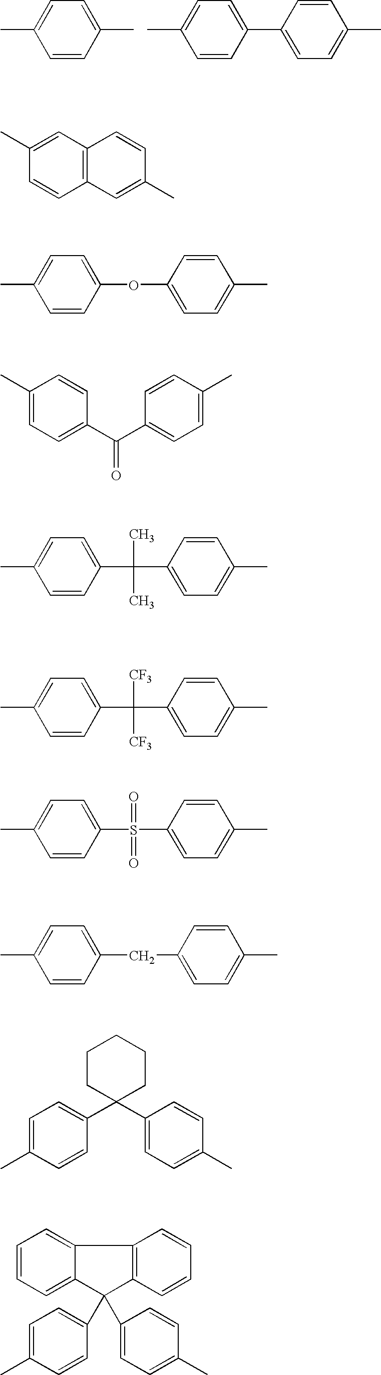

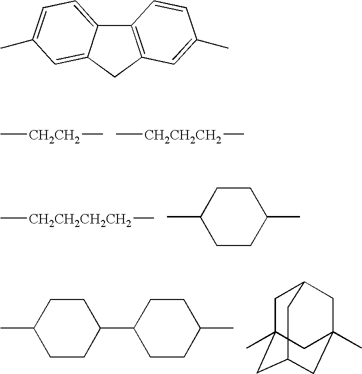

The polymer compound of the present invention having epoxy resin as a main chain can be synthesized by a polyaddition reaction between a bisepoxy compound having a skeleton represented by the formula (1) such as a compound represented by the formula (2) in which Z is epoxy, and any one of various curing agents. Examples of the curing agents include aliphatic or aromatic polyamines, acid anhydrides and polyphenols.

In this case, another epoxy compound, for example, diglycidyl ether of bisphenol A, glycidyl esters, glycidylamines, or cycloaliphatic epoxides may be copolymerized in order that the variety of resin properties may be exerted. In addition, tertiary amine or Lewis acid complex may be used as a catalytic curing agent for promoting a curing reaction.

A solvent, which is used in the polymerization reaction, the storage of a solution, or the formation of a thin film of the polymer compound of the present invention, is not particularly limited as long as it does not inhibit a polymerization reaction and can dissolve a monomer and a polymer. Specific examples of a preferable solvent include: benzene; toluene; xylene; mesitylene; cyclopentanone; cyclohexanone; N-methyl-2-pyrrolidone; formamide; N,N-dimethylformamide; N,N-dimethylacetamide; N,N-dimethylimidazolidinone; dimethyl sulfoxide; hexamethylphosphoric triamide; sulfolane; y-butyrolactone; tetrahydrofuran; dioxane; dichloromethane; chloroform; and 1,2-dichlorethane. Of those, cyclohexanone, N-methyl-2-pyrrolidone, N,N-dimethylacetamide, and tetrahydrofuran are more preferable. Each of those solvents may be used alone, or two or more of them may be used as a mixture.

Furthermore, a solvent having a low surface tension may be used in combination as required for the purpose of improving application property. Specific examples of such solvent include: alkyl lactate; 3-methyl-3-methoxybutanol; tetralin; isophorone; ethylene glycol monoalkyl ether such as ethylene glycol monobutyl ether; diethylene glycol monoalkyl ether such as diethylene glycol monoethyl ether; ethylene glycol monoalkyl (or phenyl) acetate; triethylene glycol monoalkyl ether; propylene glycol monoalkyl ether such as propylene glycol monobutyl ether; and dialkyl malonate such as diethyl malonate. Most of those solvents are poor solvents with respect to the above-mentioned good solvents. Therefore, each of those poor solvents is preferably added in such an amount that dissolved components do not precipitate.

Furthermore, a surfactant to be used for the purpose of improving application property and an antistatic agent to be used for the purpose of preventing charging can also be added. Alternatively, a silane coupling agent or a titanium-based coupling agent can be blended for additionally improving adhesiveness to a substrate.

Examples of a preferable silane coupling agent include: vinyl trimethoxysilane; vinyl triethoxysilane; N-(2-aminoethyl)-3-aminopropylmethyldimethoxysilane; N-(2-aminoethyl)-3-aminopropyltrimethoxysilane; 3-aminopropyltriethoxysilane; 3-aminopropyltrimethoxysilane; 3-glycidoxypropyltrimethoxysilane; 2-(3,4-epoxycyclohexyl)ethyltrimethoxysilane; 3-chloropropyltrimethoxysilane; 3-methacryloxypropyltrimethoxysilane; and 3-mercaptopropyltrimethoxysilane.

A thin film can be formed by dissolving the polymer compound of the present invention into such solvent as described above; and applying the resultant solution to a substrate.

Any ordinarily used method can be used as a method of applying a polymer solution to a substrate to form a thin film on it. Examples of an available method include a spinner method, a printing method, a dipping method, and a dropping method. Although the solvent composition and concentration of an oligomer solution upon application maybe identical to those at the time of polymerization, after a reaction solvent has been removed by means of, for example, vacuum concentration, the concentration and composition of the solution may be optimized, and applied. A glass substrate, a plastic substrate, a film-like substrate, or the like can be used as a substrate.

In addition, a heat treatment necessary for drying the solvent after such solution has been applied can be performed by means of a method similar to that used in the ordinary formation of an interlayer insulating film, a protective film, a liquid crystal alignment layer, or an optical waveguide. For example, an oven, a hot plate, or an infrared furnace can be used for drying. After the solution has been applied, the solvent is evaporated at a relative low temperature, and then a heat treatment is preferably performed at a temperature of about 100 to 500° C., or preferably 150 to 450° C. A heating temperature may be constant, or may be increased in a stepwise manner. A heating time, which varies depending on the kind of a polymer, is preferably about 10 to 180 minutes, or more preferably about 30 to 90 minutes. The heat treatment maybe performed in the air, in a nitrogen atmosphere, or under reduced pressure.

The thin film thus formed is useful as, for example, an insulating film, a protective film, a liquid crystal alignment layer, or a planarized film. The size and thickness of the film can be appropriately set in accordance with applications.

The term “insulating film” means, for example, a film having a function of electrically insulating metal wiring in which a current flows in the multi-layer interconnection structure of LSI.

The term “protective film” means, for example, a film formed on the uppermost part of the multi-layer interconnection structure of LSI and having a function of protecting the inside of the wiring from external contamination etc.

The insulating film and protective film of the present invention are suitably used for producing an electrical fixed installation such as a semiconductor.

The term “planarized film” means, for example, a film with which a substance having a corrugated surface is coated to provide a planarized surface.

The term“liquid crystal alignment layer” means, for example, a film having a function of expressing the uniaxial orientation of a liquid crystal molecule in a liquid crystal display device and a pretilt angle at an interface.

The planarized film and liquid crystal alignment layer of the present invention are suitably used for producing a liquid crystal display device.

Furthermore, the polymer compound of the present invention can be used as a material for an optical waveguide.

The term “material for an optical waveguide” means, for example, a material having a function of guiding a light signal trapped in a specific region from an incidence end to an emission end in an optical functional device such as an optical fiber or optical wiring.

An optical waveguide can be produced on the basis of a conventionally known method (for example, JP2005-010770A, JP2005-029652A, and JP2004-182909A). For example, the optical waveguide is produced by the following procedures. At first, a polymer compound to be used for an optical clad material is applied to a substrate to form a film. Then, a polymer compound for an optical core material is applied, and then an etching mask is mounted on the resultant applied layer. After that, the resultant is processed into a waveguide pattern by means of a photolithography approach. An organic photoresist, a metal, or the like is used as a material for the etching mask. Next, the optical core layer is subjected to reactive ion etching over the etching mask, whereby a desired waveguide pattern can be formed. This method is particularly effective in producing a single mode-type optical waveguide. JP09-329721A describes a method of producing an optical waveguide to be used for an optical waveguide-type reduced image sensor. The polymer compound of the present invention is suitable for the preparation of such optical waveguide.

### EXAMPLES

Hereinafter, the present invention will be described in more detail by referring to examples. However, the present invention is not limited to these examples.

The physical properties of the compounds obtained in the examples were measured by means of the following methods.

Melting point: A polarization microscope was mounted with the hot stage (FP-82 manufactured by Mettler-Toledo K.K.) to carry out measurement at a rate of temperature increase of 5° C. per minute.

Infrared absorption spectrum (IR): Measurement was performed at room temperature according to KBr method by means of FT/IR-7000 manufactured by JASCO.

Proton NMR spectrum (¹H-NMR): Measurement was performed at room temperature by using JNM-GSX 400 manufactured by JEOL, chloroform-d or tetrahydrofuran-d₈ as a solvent at 400 MHz, and tetramethylsilane as an internal standard substance.

Silicon NMR spectrum (²⁹Si-NMR): Measurement was performed at room temperature by using JNM-GSX 400 manufactured by JEOL, chloroform-d or tetrahydrofuran as a solvent at 79 MHz, and tetramethylsilane as an internal standard substance.

Measurement was performed by means of GPC with tetrahydrofuran as a mobile phase by using GULLIVER 1500 series HPLC system manufactured by JASCO.

Heat decomposition temperature: Measurement was carried out in the air at a rate of temperature increase of 10° C. per minute by means of TG/DTA-220 manufactured by SEIKO INSTRUMENTS INC. The temperature at which a weight is reduced by 5% was defined as a decomposition temperature.

Glass transition temperature: Measurement was carried out at a rate of temperature increase of 5° C. per minute by means of DSC-200 manufactured by SEIKO INSTRUMENTS INC.

### Example 1

Synthesis of organosilicon compound represented by the formula (2) in which X is phenyl, Y is methyl, and Z is —C≡C—Ph (Compound 3);

Hereinafter, detailed procedures are shown by each step. 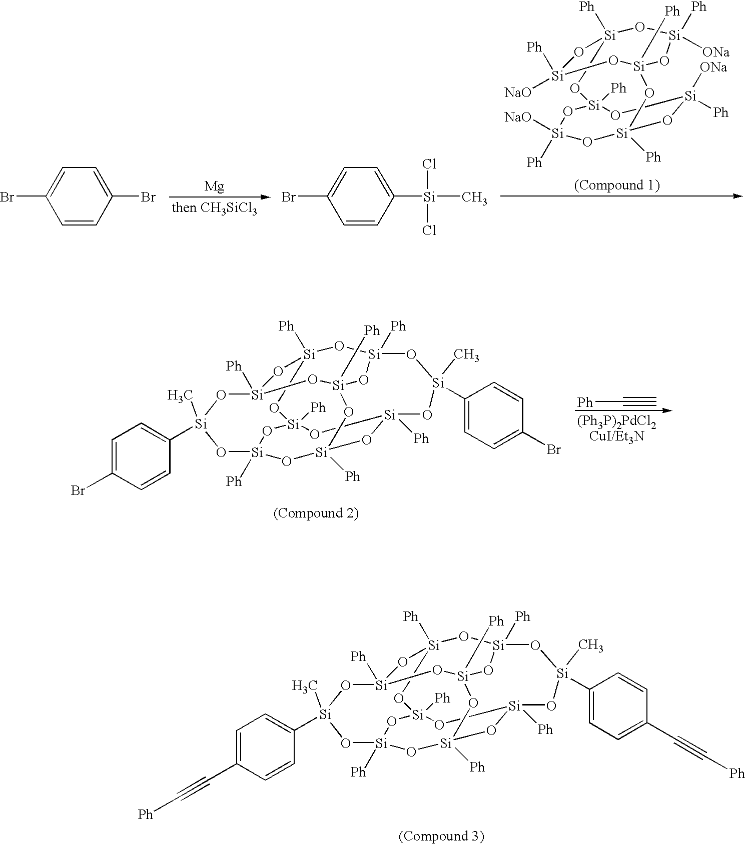
(1) Synthesis of the Compound 2

2.0 g (7.4 mmol) of 4-bromophenylmethyldichlorosilane (synthesized according to Kohama et al., Japanese Journal of Chemistry, vol. 79, eleventh edition, p. 1307 (1958)) was added dropwise at room temperature to a solution prepared by suspending 3.88 g (3.36 mmol) of a double-decker sodium salt (Compound 1) into tetrahydrofuran (hereinafter, THF), and then the whole was stirred for 3 hours. Water was added to the reaction system, followed by twice of extraction with toluene. An organic layer was dried with magnesium sulfate, and then concentrated by means of a rotary evaporator. The resultant white solid was recrystallized from toluene to yield 2.57 g (1.75 mmol) of the Compound 2 as a white solid (52% yield, melting point: 278.2° C., Rf=0.3 (hexane:ethyl acetate=9:1)).

¹H-NMR (CDCl₃); δ=0.49 (6H, s), 7.13-7.51 (48H, m).

(2) Synthesis of Compound 3

1.57 g (1.1 mmol) of the Compound 2 synthesized as described above, 10 mg (0.015 mmol) of bistriphenylphosphine palladium dichloride, 330 mg (3.2 mmol) of phenylacetylene, 5 mg (0.02 mmol) of copper iodide, 12 ml of N-methyl-2-pyrrolidone (NMP), and 8 ml of triethylamine were loaded into a 100-ml round-bottomed flask, and the whole was heated and stirred at 70° C. for 1 hour in a stream of nitrogen. Water was added to the reaction system, followed by extraction with toluene. After that, an organic layer was dried with magnesium sulfate. A drying agent was filtered out, and the remaining substance was concentrated by means of a rotary evaporator. After that, the residue was subjected to silica gel column chromatography to yield 0.56 g (0.37 mmol) of the Compound 3 as a solid (37% yield, melting point: 253.6 to 259.0° C., Rf=0.26 (hexane:ethyl acetate=9:1)).

¹H-NMR (CDCl₃); δ=0.49 (2H, s), 0.52 (4H, s), 6.99-7.62 (58H, m).

¹³C-NMR (CDCl₃); δ=0.25, 89.33, 90.01, 123.09, 124.62, 124.71, 127.36, 127.45, 127.54, 127.67, 128.21, 130.1, 130.21, 130.29, 130.40, 130.46, 130.7, 130.89, 131.41, 131.47, 133.2, 133.74, 133.78, 133.85, 133.88, 134.85, 136.21, 136.25.

²⁹Si-NMR (CDCl₃); δ=−78.71, −79.34.

NMR analysis confirmed that the obtained solid was a cis-trans mixture.

### Example 2

Synthesis of the organosilicon compound represented by formula (2) in which X is phenyl, Y is methyl, and Z is hydroxyl (Compound 5);

Hereinafter, detailed procedures are shown by each step. 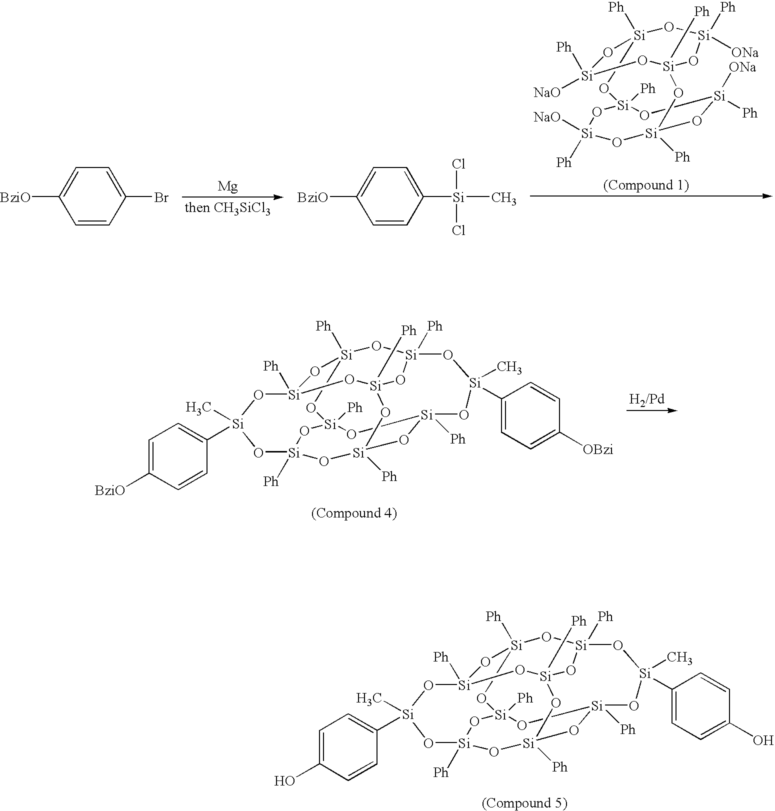
(1) Synthesis of Compound 4

A THF solution of 4-benzyloxyphenylmethyldichlorosilane (synthesized according to JP2000-159714A) was added dropwise at room temperature to a solution prepared by suspending 3.86 g (3.33 mmol) of the Compound 1 into 20 ml of THF, and then the whole was stirred for 3 hours. Water was added to the reaction system, followed by twice of extraction with toluene. An organic layer was dried with magnesium sulfate, and then concentrated by means of a rotary evaporator. The resultant oily matter was subjected to silica gel column chromatography. The resultant solid was recrystallized from toluene to yield 1.58 g (1.00 mmol) of the Compound 4 as a white solid (30.3% yield, melting point: 198.4° C., Rf=0.206 (hexane:ethyl acetate=9:1)).

¹H-NMR (CDCl₃); δ=0.49 (6H, s), 4.98 (4H, s), 6.79-6.82 (4H, m), 7.07-7.58 (54H, m).

²⁹Si-NMR (CDCl₃); δ=−78.3, −79.46.

(2) Synthesis of Compound 5

0.6 g (0.39 mmol) of the Compound 4 synthesized as described above was dissolved into 15 ml of THF. 3 ml of 1N hydrochloric acid and 0.12 g of 10% palladium carbon were added to the solution, and the whole was stirred at room temperature in a hydrogen atmosphere for 5 days. The reactant was subjected to CELITE filtration, washed with water, extracted with toluene, and dried with magnesium sulfate. After the extract had been concentrated, the precipitated solid was recrystallized from a hexane-ethyl acetate solvent to yield 0.15 g (0.11 mmol) of the Compound 5 as a white solid (29% yield, melting point: 300° C. or higher, Rf=0.49 (hexane:ethyl acetate=1:1)).

¹H-NMR (CDCl₃); δ=0.49 (6H, s), 4.8 (2H, s), 6.81 (4H, d, J=8 Hz), 7.1-7.71 (48H, m).

²⁹Si-NMR (THF-d₈); δ=−82.2, −83.3.

NMR analysis confirmed that the obtained solid was a cis-trans mixture.

### Example 3

Synthesis of the organosilicon compound represented by formula (2) in which X is phenyl, Y is methyl, and Z is vinyl

2.4 g of triethylamine were added to a solution prepared by suspending 9.3 g (8.0 mmol) of the Compound 1 into 80 ml of THF, and the whole was stirred at room temperature. 5.2 g (2.4 mmol) of styrylmethyldichlorosilane (synthesized according to JP59-126478A) were added dropwise at room temperature to the obtained solution, followed by stirring for 5 hours. The precipitated salt was filtered out, and the filtrate was concentrated under reduced pressure. The concentrate was dissolved into 30 ml of THF, and the salt was filtered out again. The filtrate was concentrated and loaded into 250 ml of methanol. The precipitated target substance was filtered out and dried under reduced pressure to yield 7.9 g (5.8 mmol) of a white solid (73% yield).

¹H-NMR (CDCl₃); δ=0.51 (6H, s), 5.25, 5.27 (2H,dd), 5.70, 5.75 (2H,dd), 6.63-6.72 (2H, m), 7.02-7.61 (48H, m).

²⁹Si-NMR (THF); δ=−30.5, −77.9, −78.8, −79.1, −79.2.

### Example 4

Synthesis of the organosilicon compound represented by formula (2) in which X is phenyl, Y is methyl, and Z is epoxide 4.6 g (3.4 mmol) of the (divinyl) compound synthesized in Example 3 was suspended in a solution consisting of 60 ml of dichloromethane, 1,2-dibromoethane, and 60 ml of perfluorohexane, and the whole was stirred at room temperature. 1.7 g (10.0 mmol) of m-chloroperoxybenzoic acid was added to the suspension and the obtained solution was stirred at room temperature for 19 hours. The reaction solution was transferred to a separating funnel and the solution of the lowest layer was taken, and the solution was washed once with sodium bicarbonate water, and then twice with pure water. After the organic layer was dried with magnesium sulfate anhydride, the drying agent was filtered out and the remaining substance was concentrated under reduced pressure. The obtained solid was dissolved into a small amount of THF, and the solution was poured into a larger amount of methanol for re-precipitation. The re-precipitate was filtered, and washed with a small amount of cooled ethyl acetate, followed by drying under reduced pressure, thereby 2.5 g of target substance was obtained as a white solid (53% yield).

Rf=0.57, 0.47 (hexane:ethylacetate=2:1).

¹H-NMR (CDCl₃); δ=0.51 (6H, s), 2.69 (2H, t), 3.10, 3.11 (2H, q), 3.79 (2H, t), 7.07-7.64 (48H, m).

²⁹Si-NMR (THF); δ=−30.51, −77.83, −78.90, −79.0, −79.04, −79.11.

The Rf value and the result of NMR showed that the obtained compound is a mixture of diastereomers.

### Example 5

Synthesis of the organosilicon compound represented by formula (2) in which X is phenyl, Y is methyl, and Z is an amino group (Compound 7);

Hereinafter, detailed procedures are shown by each step.

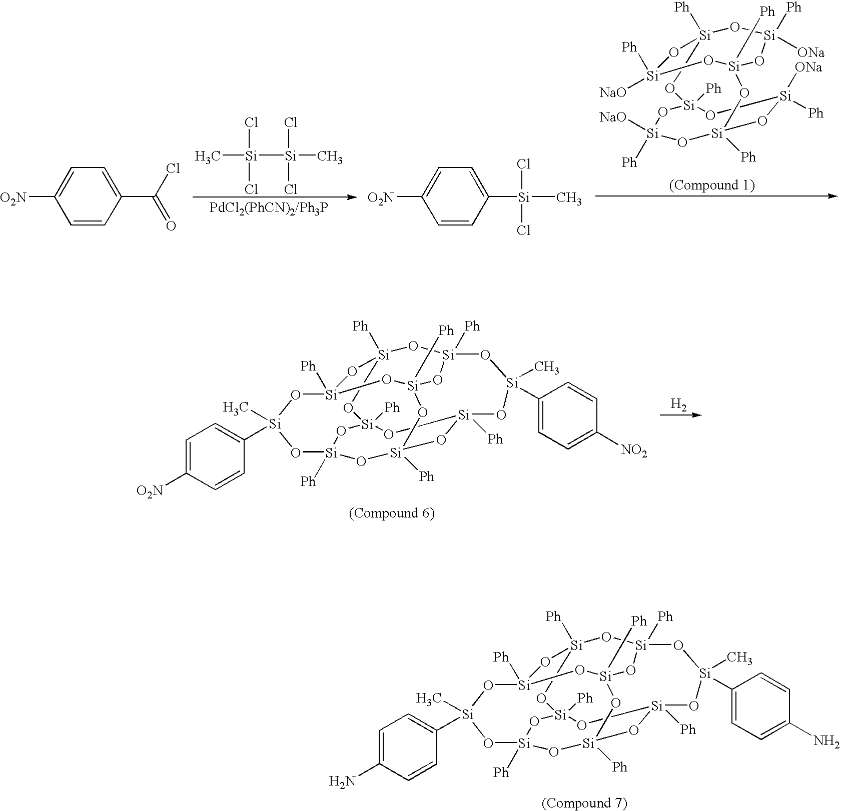

(1) Synthesis of 4-nitrophenylmethyldichlorosilane (synthesized according to J. D. Rich., J. Am. Chem. Soc., 111, 5886 (1989))

8.1 g (44 mmol) of p-nitrobenzoylchloride and 10.0 g (44 mmol) of 1,1,2,2-tetrachloro-1,2-dimethyldisilane were loaded into a 100-ml three-necked flask. Then, 0.2 g (0.9 mmol) of triphenylphosphine and 0.2 g (0.4 mmol) of bis(benzonitrile)dichloropalladium (II) were added to the flask, and the whole was heated to 140° C. while stirring in a stream of nitrogen. After heating at 140° C. for 12 hours, a vacuum distilling device was installed in the flask, and a fraction of 130 to 136° C./0.80 kPa was taken to yield 1.8 g of a yellow transparent liquid (17.4% yield). The compound was immediately used for the next reaction.

(2) Synthesis of Compound 6

2.9 g (3 mmol) of the Compound 1 and 0.3 g (3 mmol) of triethylamine were added to 30 ml of tetrahydrofuran, and the whole was stirred in a nitrogen atmosphere. 1.8 g (8 mmol) of dichlorosilane obtained in the above (1) was added dropwise to the solution, and the whole was stirred at room temperature for 3 hours. The reactant solution was poured into excessive water, followed by twice of extraction with ethyl acetate. An organic layer was taken and dried with anhydrous magnesium sulfate. A drying agent was filtered out, and then the remaining substance was concentrated under reduced pressure to yield yellow oily substance.

A small amount of ethyl acetate was added to the oily substance for crystallization. After the generated crystal had been filtered out, the filtrate was concentrated under reduced pressure. The resultant oily matter was purified by means of silica gel column chromatography (hexane:ethyl acetate=5:1), and the resultant solid matter was dried under reduced pressure to yield 0.9 g (0.6 mmol) of Compound 6 as a white powder (24.2% yield, melting point: 130° C., Rf=0.6 (hexane:ethyl acetate=2:1)).

¹H-NMR (CDCl₃) ; δ=0.61 (6H, s), 7.12-8.05 (48H, m)

(3) Synthesis of Compound 7

0.8 g (0.6 mmol) of the Compound 6 synthesized in the above (2) was dissolved into 100 ml of ethyl acetate. 0.1 g of 10% palladium carbon was added to the solution, and the whole was stirred at room temperature in a hydrogen atmosphere for 14 hours. The catalyst was filtered out, and the filtrate was concentrated under reduced pressure to yield 0.8 g of semitransparent oily matter.

Small amounts of hexane and ethyl acetate were added to the oily matter for crystallization. The crystal was collected by filtration, and concentrated under reduced pressure to yield 0.5 g (0.4 mmol) of the Compound 7 as a white powder (61.4% yield, melting point: 195° C., Rf=0.5 (hexane:ethyl acetate=1:1)).

¹H-NMR (CDCl₃); δ=0.49 (6H, s), 3.62 (4H, bs), 6.48-7.57(48H, m).

²⁹Si-NMR(CDCl₃); δ=−30.3, −78.7, −79.6, −79.9.

### Example 6

Synthesis of the organosilicon compound represented by the formula (3) in which X is phenyl and Y is methyl (Compound 8)

Hereinafter, detailed procedures are shown by each step.

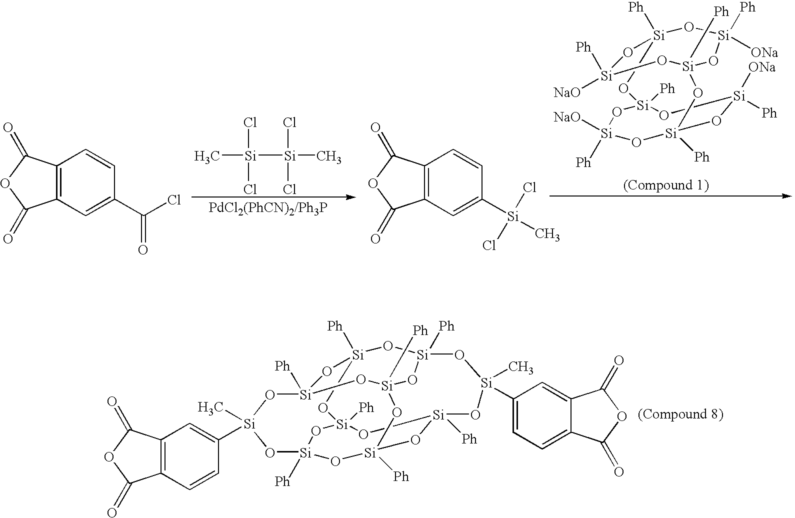

(1) Synthesis of 4-(dichloromethylsilyl)phthalic anhydride (synthesized according to J. D. Rich., J. Am. Chem. Soc., 111, 5886 (1989));

18.5 g (88 mmol) of trimellitic anhydride chloride, 20.0 g (88 mmol) of 1,1,2,2-tetrachloro-1,2-dimethyldisilane, 0.2 g (0.8 mmol) of triphenylphosphine, and 0.2 g (0.4 mmol) of bis(benzonitrile)dichloropalladium (II) were used to perform the same reaction operation as in Example 4. In vacuum distillation, a fraction of 140 to 146° C./0.13 kPa was taken to yield 5.4 g of a transparent liquid (23.6% yield). The compound was immediately used for the next reaction.

(2) Synthesis of Compound 8

10.0 g (9.0 mmol) of the Compound 1 were added to 100 ml of THF, and the whole was stirred in a nitrogen atmosphere. 5.4 g (21 mmol) of dichlorosilane obtained in the process (1) were added dropwise to the suspension, and the whole was stirred at room temperature for 22 hours. The reaction solution was filtered, and then the filtrate was concentrated under reduced pressure to yield 7.5 g of semitransparent oily matter.

A small amount of ethyl acetate was added to the oily matter. The precipitated solid was filtered out, and then the filtrate was concentrated under reduced pressure to yield a yellowish white viscous substance. The substance was purified by means of silica gel column chromatography (ethyl acetate alone), and spots other than the origin were removed by means of TLC (hexane:ethyl acetate=2:1). Subsequently, the resultant concentrate was crystallized in a small amount of hexane/ethyl acetate, and the resultant solid matter was dried under reduced pressure to yield 1.1 g (0.8 mmol) of Compound 8 as a white powder (8.8% yield, melting point: 195° C.)

¹H-NMR (CDCl₃); δ=0.58 (6H, s), 7.14-8.17(46H, m)

²⁹ Si-NMR(CDCl₃); δ=−32.8, −77.4, −78.8.

### Example 7

Synthesis of Polyimide

0.5019g (0.376 mmol) of the diamine (Compound 7) synthesized in Example 5 was dissolved into 1.5035 g of cyclohexanone, and the solution was stirred at room temperature. 0.5033 g (0.376 mmol) of the acid dianhydride (Compound 8) synthesized in Example 6was added in the form of a solid to the solution. Varnish obtained by stirring the reactant at room temperature for 12 hours was diluted with cyclohexanone at a concentration of 20%, and then filtered by a membrane filter of 0.5 micron. The solution was applied onto a glass substrate by means of a spinner method, followed by heating for 3 minutes on a hot plate at 100° C. Subsequently, the obtained substrate was placed in an oven at 250° C. and baked for 1 hour under a nitrogen atmosphere. As a result, a pale yellow thin film was obtained. The glass-transition temperature of this polyimide was 201° C.

### Example 8

Synthesis of Polyimide

Synthesis was performed in the same manner as in Example 7 except that 0.1440 g (0.108 mmol) of the diamine (Compound 7) synthesized in Example 5 and 0.0349 g (0.108 mmol) of 3,3′,4,4′-benzophenonetetracarboxylic dianhydride were used as monomers, and thereby a polyimide thin film was produced. The glass-transition temperature of this polyimide was 197° C.

### Example 9

Synthesis of Polyimide

Synthesis was performed in the same manner as in Example 7 except that: 0.2012 g (1.00 mmol) of 4,4′-diaminodiphenylether was used as a diamine component; and 1.3989 g (0.98 mmol) of the acid anhydride (Compound 8) synthesized in Example 6 were used, and thereby a polyimide thin film was produced. The glass-transition temperature of this polyimide was 188° C.

### Example 10

Synthesis of Polyamide

0.5019 g (0.376 mmol) of the diamine (Compound 7) synthesized in Example 5 was dissolved into 1.11 g of NMP, and the solution was stirred under ice cooling. 0.0762 g (0.376 mmol) of terephthalic dichloride was added in the form of a solid to the solution. After the temperature of the solution returned to room temperature, the solution was stirred for 3 hours. The reactant solution was poured into 100 ml of methanol to precipitate a polymer. The precipitate was collected by filtration, and a white solid was dried under reduced pressure to yield a polyamide. The pyrolysis temperature of this polymer was 509° C., and glass transition was not observed.

### Example 11

Synthesis of Polycarbonate

1.000 g (0.747 mmol) of the biphenol (Compound 5) synthesized in Example 2 was dissolved into 1.25 ml of 1,2-dichloroethane, followed by stirring under room temperature. Then, 0.24 ml (2.99 mmol) of pyridine was added to the solution, followed by stirring while raising temperature to 70° C. Next, a solution obtained by dissolving 0.100 g (0.298 mol) of triphosgene into 20 ml of dichloroethane was dropped into the solution, followed by stirring at 70° C. for 3 hours. After the temperature of the solution returned to room temperature, the resultant solution was poured into 100 ml of methanol to precipitate polymers. The precipitate was collected by filtration, and a white solid was dried under reduced pressure to yield a polycarbonate. The pyrolysis temperature of this polymer was 506° C., and glass transition was not observed.

### Example 12

Synthesis of Polyester;

1.0834g (0.810 mmol) of the biphenol (Compound 5) synthesized in Example 2 was dissolved into 7 ml of 1,2,4-trichlorobenzene, followed by stirring under nitrogen atmosphere at 150° C. A solution obtained by dissolving 0.1644 g (0.810 mmol) of terephthaloyl dichloride into 3 ml of trichlorobenzene was dropped into the solution, followed by stirring at 220° C. for 3 hours. After the temperature of the solution returned to room temperature, the resultant solution was poured into 100 ml of methanol to precipitate polymers. The precipitate was collected by filtration, and a white solid was dried under reduced pressure to yield a polyester. The pyrolysis temperature of this polymer was 492° C., and glass transition was not observed.

1. A polymer compound comprising a silsesquioxane skeleton represented by the formula (1) in its polymer main chain. 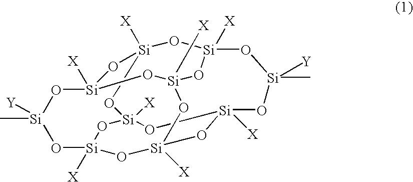
In the formula (1), each of X and Y independently represents a hydrogen or a monovalent organic group having 1 to 40 carbon atoms.

2. The polymer compound according to claim 1, wherein: X in the formula (1) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

3. The polymer compound according to claim 1, wherein X in the formula (1) independently represents methyl, ethyl, propyl, cyclohexyl, or phenyl.

4. The polymer compound according to claim 1, wherein X in the formula (1) is phenyl.

5. The polymer compound according to any one of claim 1, wherein Y in the formula (1) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and the optional —CH₂— in the alkylene of the arylalkyl may be replaced by —O—, —CH═CH—, or cycloalkylene.

6. The polymer compound according to claim 1, wherein the main chain of the polymer is a polyimide.

7. The polymer compound according to claim 1, wherein the main chain of the polymer is a polyamide.

8. The polymer compound according to claim 1, wherein the main chain of the polymer is a polyester.

9. The polymer compound according to claim 1, wherein the main chain of the polymer is a polycarbonate.

10. The polymer compound according to claim 1, wherein the polymer main chain is a polyurethane.

11. The polymer compound according to claim 1, wherein the main chain of the polymer is a polyphenylene.

12. The polymer compound according to claim 1, wherein the main chain of the polymer is an epoxy resin.

13. An organosilicon compound represented by the formula (2). 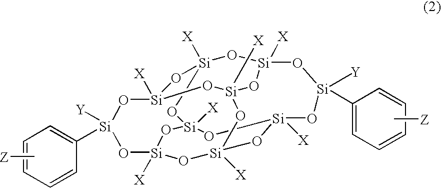
In the formula (2), each of X and Y independently represents a hydrogen or a monovalent organic group having 1 to 40 carbon atoms, and Z independently represents an amino group, hydroxyl, vinyl, epoxy, or triple bond-containing group (—C≡C—R) wherein R represents a hydrogen or a monovalent organic group having 1 to 10 carbon atoms.

14. The organosilicon compound according to claim 13, wherein: X in the formula (2) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

15. The organosilicon compound according to claim 13, wherein X in the formula (2) independently represents methyl, ethyl, propyl, cyclohexyl, or phenyl.

16. The organosilicon compound according to claim 13, wherein X in the formula (2) is phenyl.

17. The organosilicon compound according to claim 13, wherein: Y in the formula (2) independently represents hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

18. An organosilicon compound represented by the formula 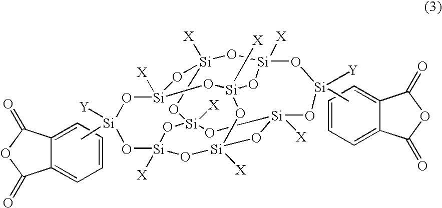
In the formula (3), each of X and Y independently represents hydrogen or a monovalent organic group having 1 to 40 carbon atoms.

19. The organosilicon compound according to claim 18, wherein: X in the formula (3) independently represents hydrogen, alkyl having 1 to 40 carbon atoms in which optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

20. The organosilicon compound according to claim 18, wherein X in the formula (3) independently represents methyl, ethyl, propyl, cyclohexyl, or phenyl.

21. The organosilicon compound according to claim 18, wherein X in the formula (3) is phenyl.

22. The organosilicon compound according to claim 18, wherein: Y in the formula (3) independently represents: hydrogen, alkyl having 1 to 40 carbon atoms whereby optional hydrogen may be replaced by fluorine and optional —CH₂— may be replaced by —O—, —CH═CH—, cycloalkylene, or cycloalkenylene, aryl in which optional hydrogen may be replaced by halogen, or with alkyl having 1 to 20 carbon atoms whereby optional hydrogen may be replaced by fluorine, and optional —CH₂— may be replaced by —O—, —CH═CH—, cycloalkylene, or phenylene, or arylalkyl in which optional hydrogen in the aryl may be replaced by halogen or alkyl having 1 to 20 carbon atoms, whereby optional hydrogen in the alkylene of the arylalkyl may be replaced by fluorine, and optional —CH₂— in the alkylene of the arylalkyl may be replaced by —O—, —CH═CH—, or cycloalkylene.

23. The polymer compound according to claim 1 obtained by performing a polymerization reaction by means of the organosilicon compound of formula (2) as a monomer.

24. The polymer compound according to claim 6 obtained by performing a polymerization reaction by means of the organosilicon compound of formula (3) as a monomer.

25. The polymer compound according to claim 6, wherein the polymer compound is obtained by performing polymerization using the organosilicon compound of formula (2) in which Z represents an amino group, and the organosilicon compound of formula (3).

26. A thin film comprising the polymer compound according to claim 1.

27. An insulating film comprising the thin film according to claim 26.

28. A protective film comprising the thin film according to claim 26.

29. A liquid crystal alignment layer comprising the thin film according to claim 26.

30. A planarized film comprising the thin film according to claim 26.

31. A material for an optical waveguide comprising the thin film according to claim 26.

32. An electrical solid state device comprising the insulating film according to claim 27.

33. An electrical solid state device comprising the protective film according to claim 28.

34. A liquid crystal display comprising the liquid crystal alignment layer according to claim 29.

35. A liquid crystal display comprising the planarized film according to claim 30.

36. An optical waveguide comprising the material for an optical waveguide according to claim 31.

37. A thin film comprising the polymer compound according to claim 6.
